(19) United States
(12) Patent Application Publication
(10) Pub. No.: US 2005/0202833 A1
(43) Pub. Date: Sep. 15, 2005

(54) Radio wave transmission source location specifying system, apparatus and method, information processing apparatus, and computer program therefor

(75) Inventor: Ryota Motobayashi, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 11/043,988

(22) Filed: Jan. 28, 2005

(30) Foreign Application Priority Data
Mar. 15, 2004 (JP) 2004-072986

(51) Int. Cl. H04Q 7/20

(52) U.S. Cl. 455/456.5; 455/67.11

(57) ABSTRACT

An information terminal (1), a control device (3), and a plurality of direction sensing devices (5) constitute a radio wave transmission source location specifying system. The control device (3) specifies a location to be specified from where a target radio wave with a predetermined frequency is transmitted, by communicating with the information terminal (1) to be used by a user and the direction sensing devices (5) via a communication line (2). At this time, the information terminal (1) is provided from the control device (3) with a remote control function enabling remote control of operations of the direction sensing devices (5). Then, a transmission source location of the target radio wave is specified in the control device (3), in response to specification of an arrival direction in which the target radio wave with the predetermined frequency arrives in the information terminal (1), on the basis of the arrival direction and positional information on the direction sensing devices, by using the remote control function. The user is notified of information on the transmission source location of the target radio wave specified in such a manner that the user can recognize the information in the information terminal (1).

### BACKGROUND OF THE INVENTION

1. Field of the Invention

The present invention relates to a technical field of specifying the location of an electromagnetic wave (electric wave including a radio wave) transmission source, and more particularly to a technical field of specifying the location of an electromagnetic wave transmission source through a remote operation from an external device.

2. Description of the Related Art

In the technical field of radio communication, there have been proposed arts for specifying the location or direction of a radio wave transmission source so as to handle the unexpected interference of radio waves or the deliberate interference intended for communication jamming.

As an example of such arts, an information providing device for specifying the transmission source location of an HF radio wave received via an antenna is proposed in JP 2002-090438 A. When the information providing device specifies the location of the radio wave transmission source, consideration is given to ionosphere altimeter data obtained from an external device with the aid of the Internet network.

Further, a method of detecting the location of a moving object using the level of radio waves emitted therefrom is proposed in JP 01-292277 A. In this method, two receivers each having a rotatable antenna mechanism individually receive radio waves emitted from the moving object. In this method, the directions of the radio waves can be individually specified by the respective receivers on the basis of the levels of the received radio waves and the directions of antennae. Thus, in this method, extended lines are drawn along the radio wave directions individually specified by the two receivers, and an intersection point of the two extended lines is found to thereby detect the location of the moving object (i.e.; the location of the radio wave transmission source).

Still further, a radio wave direction finder having different kinds of receiving antennae in a reference position is proposed in JP 05-302969 A. The radio wave direction finder specifies the direction of a radio wave transmission source using different receiving areas and directivities of the receiving antennae.

Various arts for specifying the location or direction of a radio wave transmission source generally have the following demands as their background.

That is, as a first example, radio wave interference in business radio communication can be mentioned. In general, with a view to considering the coverage of radio waves, public offices having jurisdiction over business radio communication allocate the same frequency to users residing geographically sufficiently remote from the coverage. However, even in the case where such consideration is previously given, unexpected propagation of transmitted radio waves may cause interference among different users to which the same frequency is allocated.

Further, as a second example, radio wave interference in amateur radio communication or simplified radio communication can be mentioned. In some systems of such amateur radio communication or simplified radio communication, users can select and use arbitrary frequencies as they see fit. In systems utilized in this manner, therefore, the interference of radio waves, either deliberate or accidental, is apt to occur. Accordingly, users hindered from having communication due to the interference sometimes wish to specify the transmission source location of a radio wave causing the interference.

Still further, as a third example, radio wave interference in MCA (Multi-Channel Access)-type radio communication such as so-called personal radio can be mentioned. This MCA-type communication system primarily operates through autonomous selection of a transmission frequency. However, even in the case of such a system where a transmission frequency is selected, radios unlawfully adapted to permit operators to select and designate a frequency may hit the market. Therefore, authorized users hindered from communication by the radios thus adapted sometimes wish to specify the locations of radio waves transmitted from such radios.

As is also apparent from the above-described three examples, the demand for specification of the transmission source locations of radio waves has long been in existence.

In conventional cases, a user suffering interference most likely reports the damaging situation to a public office and requests them to devise a countermeasure in pursuit of the elimination of the present interference. In this case, the public office brings illegal radio stations to trial using a system for searching radio wave transmission sources.

However, the public office does not immediately embark on the search operation with the aid of this system at the request of a user. In addition, the license to use the system is not granted to the general public. As a result, users suffering interference have no choice but to put up with the inconvenient communication environment until the current situation is canceled out.

Further, if possible, some user suffering interference sometimes draws members to conduct a down-to-earth survey for specifying the transmission source location of a target radio wave. In this case, the members each have their own receiving equipments and use them to specify the transmission source location of the target radio wave while advising one another of the direction in which the target radio wave arrives.

However, in the case where a nonprofit organization conducts such a down-to-earth survey, its activities often depend on time or equipment constraints imposed on each member participating in the organization. Therefore, there is a limit to the scope of activities.

Besides, as a rule, each nonprofit organization makes a search for the transmission source of a target radio wave using an equipment procured in its own right. In this case, the procedure of searching a radio wave transmission source or calculating a location is often peculiar to each organization and thus inefficient. Due to the fact that the procedure of searching a radio wave transmission source or calculating a location is not standardized, the uniqueness of measurement results and the inheritance of analytical know-how are problematic as well.

To solve the problems faced by the traditional activities for specifying the locations of radio wave transmission sources, it is conceivable to practice the series of activities as commercial activities. Up to now, the activities for specifying the locations of radio wave transmission sources have not been realized as so-called business.

### SUMMARY OF THE INVENTION

The present invention has been made in view of the aforementioned problems of the related art. It is an object of the present invention to quickly provide a service of precisely specifying the transmission source location of a target electromagnetic wave at the request of a common user.

To achieve the object stated above, an electromagnetic wave transmission source location specifying system according to the present invention has the following constructional features.

That is, the present invention relates to an electromagnetic wave transmission source location specifying system that specifies a location to be specified from where a target electromagnetic wave with a predetermined frequency is transmitted. The electromagnetic wave transmission source location specifying system includes:
remote control function providing means for providing an information terminal (1) to be used by a user, via a communication line (2), with a remote control function enabling remote control of operations of a plurality of direction sensing devices (5) for sensing a direction in which an electromagnetic wave with a set frequency arrives;
transmission source location specifying means for specifying a transmission source location of the target electromagnetic wave, in response to specification of an arrival direction in which the target electromagnetic wave with the predetermined frequency arrives, on the basis of the arrival direction and positional information on the direction sensing devices, by remotely controlling the operations of the direction sensing devices through the remote control function; and
notification means for notifying the user of information on the transmission source location of the target electromagnetic wave specified by the transmission source location specifying means in such a manner that the user can recognize the information in the information terminal.

Other aspects of the present invention intended to achieve the above object have the following constructional features.

That is, the present invention relates to an electromagnetic wave transmission source location specifying system that specifies a location to be specified from where a target electromagnetic wave with a predetermined frequency is transmitted. The electromagnetic wave transmission source location specifying system is provided with an information terminal (1) to be used by a user, a plurality of direction sensing devices (5) that sense a direction in which an electromagnetic wave with a set frequency arrives, and a control device (3) capable of communicating with the information terminal and the direction sensing devices via a communication line (2), and includes:
remote control function providing means for providing the information terminal, from the control device, with a remote control function enabling remote control of operations of the direction sensing devices;
transmission source location specifying means for specifying a transmission source location of the target electromagnetic wave in the control device, in response to specification of an arrival direction in which the target electromagnetic wave with the predetermined frequency arrives, on the basis of the arrival direction and positional information on the direction sensing devices, by remotely controlling the operations of the direction sensing devices through the remote control function; and
notification means for notifying the user of information on the transmission source location of the target electromagnetic wave specified by the transmission source location specifying means in such a manner that the user can recognize the information in the information terminal.

Any of the above electromagnetic wave transmission source location specifying systems preferably further includes charging means for providing the user with at least one of services available from the remote control function providing means, the transmission source location specifying means, and the notification means upon payment of a fee.

Further, for example, the transmission source location specifying means preferably includes support means for supporting the user of the information terminal in an operation of specifying an arrival direction in which a target electromagnetic wave with the predetermined frequency arrives, by referring to a database in which electromagnetic wave frequency and electromagnetic wave arrival direction are correlated with each other.

Further, for example, the direction sensing devices may be mobile stations equipped with position detecting means for detecting a current position of the self device as the positional information.

Further, for example, the transmission source location specifying means preferably includes automatic specification means for specifying an arrival direction in which a target electromagnetic wave with the predetermined frequency arrives through remote control of operations of the direction sensing devices in response to a request operation of the user and specifying a transmission source location of the target electromagnetic wave on the basis of the specified arrival direction and positional information on the direction sensing devices.

In a preferred embodiment, a man-machine interface (61) that is provided in the information terminal through the remote control function includes:
operation means (103, 203) allowing a user to change directions of receiving devices installed in the direction sensing devices; and
display areas (104, 204) indicating receiving levels of the target electromagnetic wave in the direction sensing devices.

The above object is also achieved by methods corresponding to the electromagnetic wave transmission source location specifying systems having the aforementioned respective constructions.

The above object is also achieved by a program code realizing through a computer a control device (a information processing apparatus) constituting the electromagnetic wave transmission source location specifying system having each of the aforementioned constructions, and by a computer-readable storage medium in which the program code is stored.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram showing a system configuration of a radio wave transmission source location specifying system according to a first embodiment of the present invention;

FIG. 2 is a sequence diagram showing procedures through which an information terminal, a control device, and direction sensing devices are operated until a transmission-source location of a target radio wave is specified according to the first embodiment;

FIG. 3 shows, as an example, an operational screen that is displayed in the information terminal so as to remotely operate the two direction sensing devices according to the first embodiment;

FIG. 4 illustrates a principle by which the transmission source location of the target radio wave is specified with the aid of two direction sensing devices according to the first embodiment;

FIG. 5 is a sequence diagram showing procedures through which an information terminal, a control device, and direction sensing devices are operated until a transmission source location of a target radio wave is specified according to the second embodiment;

FIG. 6 is a sequence diagram showing procedures through which an information terminal, a control device, and direction sensing devices are operated until a transmission source location of a target radio wave is specified according to the third embodiment; and

FIG. 7 is a sequence diagram showing procedures through which an information terminal, a control device, and direction sensing devices are operated until a transmission source location of a target radio wave is specified according to the fourth embodiment.

### DETAILED DESCRIPTION OF THE PREFERRED EMBODIMENTS

Preferred embodiments of the present invention will now be described in detail in accordance with the accompanying drawings.

### First Embodiment

(System Configuration)

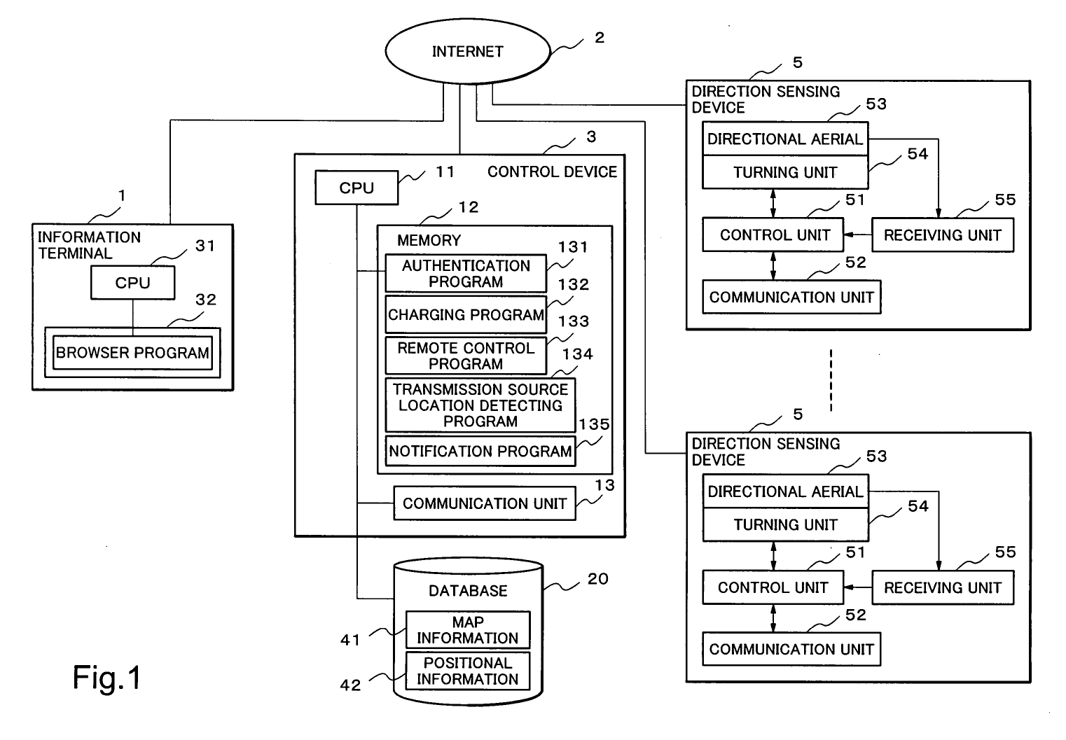

FIG. 1 is a block diagram showing the system configuration of a radio wave transmission source location specifying system according to a first embodiment of the present invention.

The radio wave transmission source location specifying system shown in FIG. 1 is mainly composed of an information terminal 1, a control device 3, and a plurality of direction sensing devices 5. These devices are connected via an internet 2, which is an example of communication line, in a manner enabling bidirectional communication.

It is to be noted herein that various system configurations such as public communication lines, dedicated communication lines, combinations thereof, combinations of wire communication and radio communication, and the like can be adopted as a physical system configuration for communicatively connecting those devices via the internet 2. A commonly used mode can be adopted nowadays as to the system configuration of the communication line and its operation itself. Thus, detailed description thereof is omitted in this embodiment.

An information processing device connectible with the internet (communication line), such as a personal computer, a mobile phone, a PDA (Personal Digital Assistance) or the like can be adopted as the information terminal 1. By executing a standard browser program in a CPU 31, the information terminal 1 can display information obtained through the internet or execute programs. The browser program is stored, for example, in a memory 32 in advance. Because the construction itself of such a device can nowadays be realized as a usual one, detailed description thereof is omitted in this embodiment.

In suffering interference or following an arbitrary moving radio station on a map, a user of the information terminal 1 utilizes the present system to specify the location of a radio wave transmission source.

The control device 3 is provided with a hardware, various software programs (131 to 135), and a communication unit 13. The hardware is composed of a CPU (Central Processing Unit) 11, a memory 12, and the like. The CPU 11 manages the overall operation of the control device 3. The software programs are executed by the CPU 11. In this embodiment, the control device 3 functions as a radio wave transmission source location specifying device that specifies the location to be specified from where a target radio wave with a predetermined frequency is transmitted, by appropriately executing the software programs 131 to 135 in the CPU 11.

The authentication program 131 is a software program (hereinafter referred to simply as a program) for confirming whether or not an access to the control device 3 by the information terminal 1 results from a predetermined user authorized to receive services of the present system.

The charging program 132 is a program for charging a corresponding information terminal 1 so as to provide the services of the present system upon payment.

The remote control program 133 is a program for remotely operating (remotely controlling) the operations of the direction sensing devices 5 from the information terminal 1.

The transmission source location detecting program 134 is a program for specifying the transmission source location of a target radio wave in response to the specification of an arrival direction in which the target radio wave arrives in the information terminal 1 through the utilization of a remote control function of the remote control program 133 in the information terminal. In specifying the transmission source location, the arrival direction of the target radio wave and positional information on the direction sensing devices 5 are utilized.

The predetermined frequency is the frequency of a radio wave whose transmission source is desired by the user to be specified with the aid of the present system (i.e., “the target radio wave” to be specified). The user sets a concrete value as the predetermined frequency in the information terminal 1.

The notification program 135 is a program for notifying the user of information on the transmission source location of the target radio wave specified by the transmission source location detecting program 134 in such a manner that the user can recognize the information in the relevant information terminal 1. As a mode of notification, for example, the presentation of a map screen where the transmission source location of a target radio wave is plotted or the presentation of the address of the transmission source location is conceivable.

The control device 3 communicates with the information terminal 1 and the direction sensing devices 5 by means of the communication unit 13, and provides the information terminal 1 with the service of specifying the transmission source locations of radio waves by executing the aforementioned respective programs (131 to 135). A common server computer (Web server), which is an example of information processing device, can be adopted as the control device 3.

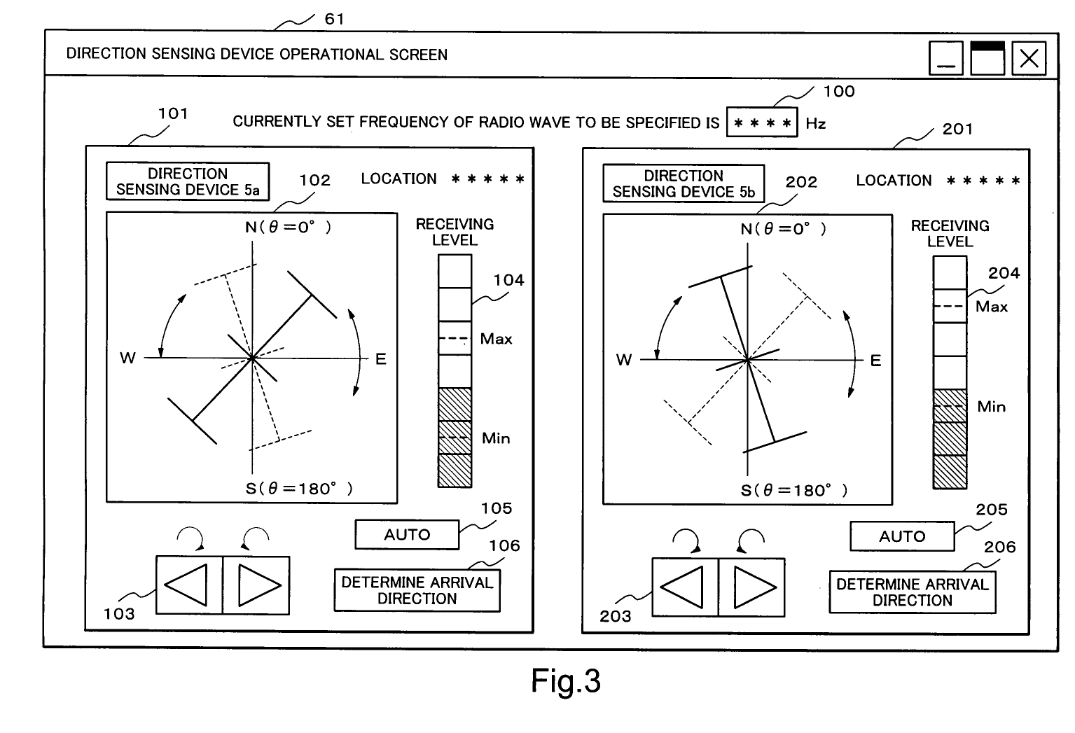

Map information 41 and positional information (which corresponds to positions Q, R shown in FIG. 3 as an example) 42 indicating the positions where the individual direction sensing devices 5 are located are stored in a database 20. By gaining access to the database 20, the control device 3 can read out the map information 41 and the positional information 42 on appropriate occasions. It is to be noted herein that the map information 41 and the positional information 42 are based on a common-standard coordinate system.

The direction sensing devices (sometimes referred to also as direction sensing stations) 5 sense a direction in which a target radio wave with a predetermined frequency set from the control device 3 arrives. The predetermined frequency of the target radio wave is the frequency (received frequency) of a radio wave to be specified (target radio wave) that has previously been set by the user of the information terminal 1 in using the present service.

Each of the direction sensing devices 5 is provided with a control unit 51, a communication unit 52, a directional aerial (antenna) 53, a turning unit 54, and a receiving unit 55.

That is, in the direction sensing devices 5, the communication unit 52 establishes at least bidirectional communication with the control device 3 via the internet (communication line) 2. The turning unit 54 is a turning mechanism for changing the orientation of the directional aerial (antenna) 53. The turning unit 54 has an encoder (not shown) that detects the orientation of the directional aerial 53. The receiving unit 55 decodes a target radio wave with a predetermined frequency, which has been received by the directional aerial 53, and detects a receiving level.

In the direction sensing devices 5, the control unit 51 drives the turning unit 54 in accordance with the information received via the communication unit 52, and sends the receiving level of a target radio wave obtained from the receiving unit 55 and the orientation of the directional aerial 53 at least to the control device 3.

In this embodiment, the direction sensing devices 5 are installed on a field (i.e., within a service range of specifying locations) with at least two of them being physically separated from each other.

(Radio Wave Transmission Source Location Specifying Processing)

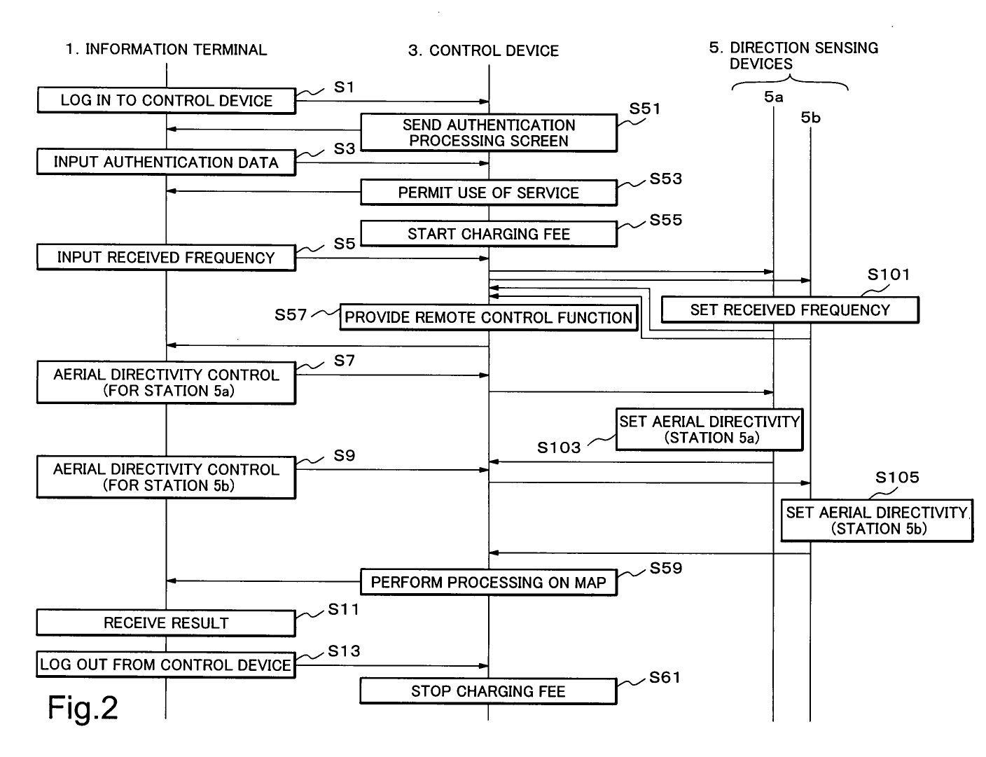

A radio wave transmission source location specifying processing realized in the system configuration as described above will be described hereinafter in detail with reference to FIGS. 2 to 4.

For convenience of explanation, out of the direction sensing devices 5 serving to specify locations, the following description deals with those two (stations) which are denoted by 5a and 5b.

FIG. 2 is a sequence diagram showing the procedures through which the information terminal, the control device, and the direction sensing devices are operated until the transmission source location of a target radio wave is specified in the first embodiment.

Referring to FIG. 2, flowcharts of longitudinal blocks represent, from the left to the right, processing procedures of software programs executed by the CPU's of the information terminal 1, the control device 3, and the direction sensing devices 5, respectively. Horizontal arrows shown between the flowcharts each represent an information communication process between the corresponding devices.

First of all, in accordance with the user's operation, the CPU 31 of the information terminal 1 gains access to the control device 3 using the internet 2 as a communication medium, and logs in to the control device 3 (step S1).

Through the function of the authentication program 131, the CPU 11 of the control device 3 sends information for displaying an authentication screen to the information terminal 1 whose log-in has been detected (step S51). Thus, the authentication screen is displayed on a Web browser operating in the information terminal 1. The user of the information terminal 1 then inputs authentication data using the authentication screen thus displayed (step S3).

Various modes can be adopted as an authentication mode. For example, an identification code (ID) for the utilization of the present system may be allocated to each user in advance, or his or her credit card number may be used. Furthermore, the user may be required to enter a password.

Through the function of the authentication program 131, the CPU 11 of the control device 3 determines, on the basis of the authentication information input to the information terminal 1 in step S3, whether or not the user is qualified to use the present system. If it is determined that the user is allowed to use the present service, the CPU 11 sends information for permitting the use of the service (information for permitting access to specific Web pages and the like) to the information terminal 1 (step S53).

Then, through the function of the charging program 132, the CPU 11 of the control device 3 starts a charging processing of charging the user for the use of the present service (step S55).

Primitive charging information on the charging processing may include the number of frequencies of target radio waves whose locations are desired by the user to be specified (i.e., the number of targets to be specified), the length of occupation period of the CPU 11, and the like. It is to be noted, however, that this embodiment is not limited to the form of the charging processing.

In response to permission of the use of the service in the processing of step S53 in the control device 3, the user inputs to the information terminal 1 the frequency of a target radio wave whose transmission source location is to be specified (step S5) The input frequency of the target radio wave is set for the direction sensing devices 5a, 5b via the control device 3 (step S101). The same frequency set for the direction sensing devices 5a, 5b in step S101 is the received frequency of a radio wave that is to be received by the receiving unit 55 of each of the two devices 5a, 5b from the outside via the directional aerial 53.

Upon receiving from the direction sensing devices 5a, 5b the information indicating the completion of the setting of the frequency of the target radio wave, the CPU 11 of the control device 3 starts providing the information terminal 1 in its log-in state with the remote control functions of the direction sensing devices 20, 5a, 5b (step S57). At this moment, the control device 3 sends information for displaying an operational screen as illustrated in FIG. 3 as an example in the information terminal 1. The remote control functions are provided through the execution of the remote control program 133 by the CPU 11.

In response to the processing of step S57 in the control device 3, the information terminal 1 provides the user with an environment for remotely operating (remotely controlling) the direction sensing devices 5a, 5b (steps S7 and S9). In response to remote operation signals sent from the information terminal 1 in steps S7 and S9, the direction sensing devices 5a, 5b control the orientation of the directional aerial 53 (steps S103 and S105).

That is, the CPU 31 of the information terminal 1 displays remote operational screens of the direction sensing devices 5a, 5b on a display (not shown) by means of the operating Web browser.

FIG. 3 shows, as an example, an operational screen that is displayed in the information terminal so as to remotely operate the two direction sensing devices in the first embodiment. This operational screen 61 functions as a man-machine interface (or a GUI: Graphical User Interface) allowing the user of the information terminal 1 to remotely operate the orientation of the directional aerial 53 provided in each of the direction sensing devices 5a, 5b so as to specify the direction in which a target radio wave arrives.

The operational screen 61 shown in FIG. 3 is mainly composed of a direction sensing device operation window 101 for remotely operating the direction sensing device 5a and a direction sensing device operation window 201 for remotely operating the direction sensing device 5b. The frequency currently set for the two direction sensing devices (i.e., the frequency input by the user in step S5) is displayed in a display area 100.

In a display range of the direction sensing device operation window 101 (201), a direction display area 102 (202), a turning command button 103 (203), a receiving level indicator 104 (204), an automatic determination starting button 105 (205), and a radio wave arrival direction determining button 106 (206) are displayed.

In the direction display area 102 (202), the current direction (orientation) of the directional aerial 53 is displayed. This direction is displayed on the basis of angle information received from the control device 3 in step S57, which is output from an encoder (not shown) of the turning unit 54.

The turning command button 103 (203) is a software button for turning the turning unit 54 clockwise and counterclockwise so as to change the orientation of the directional aerial 53. The CPU 31 of the information terminal 1 sends operational information corresponding to the operation of the turning command button 103 (203) to the direction sensing device 5a (5b) via the control device 3.

In the receiving level indicator 104 (204), the receiving level of a target radio wave being received by the directional aerial 53 (i.e., the field intensity of the received radio wave) is displayed. This receiving level is displayed on the basis of receiving level information received from the control device 3 in step S57, which is output from the receiving unit 55.

That is, the user operates the turning command button 103 (203) while paying attention to a level value displayed in the receiving level indicator 104 (204) on the operational screen 61. The user then specifies a direction of the directional aerial 53 corresponding to a maximum or minimum value of the displayed level by referring to the direction display area 102 (202).

The radio wave arrival direction determining button 106 (206) is a software button that is operated by the user in determining the direction in which a target radio wave arrives. Namely, when the level value displayed on the operational screen 61 reaches its maximum or minimum, the user stops operating the turning command button 103 (203) and then operates the button 106 (206). The CPU 31 of the information terminal 1 sends to the control device 3 information indicating that this button has been operated (or angle information itself). Thus, the CPU 11 of the control device 3 recognizes the angle information currently output from the turning unit 51 of the direction sensing device 5a (5b) as the direction in which the target radio wave arrives.

The automatic determination starting button 105 (205) is a software button that is operated when the above series of operations before determining the arrival direction of the target radio wave are to be performed not by the user but automatically. If this button is operated, the CPU 11 of the control device 3 automatically specifies the orientation of the directional aerial 53 corresponding to the maximum or minimum receiving level by controlling the direction sensing device 5a (5b).

The CPU 11 of the control device 3 then specifies the transmission source of the target radio wave based on the arrival direction of the target radio wave which has been specified by steps S7 and S9 in the above-mentioned information terminal 1 and steps S103 and S105 in the direction sensing devices 5a, 5b, and on the positional information 42 on the direction sensing devices 5a, 5b which is stored in the database 20 in advance (step S59).

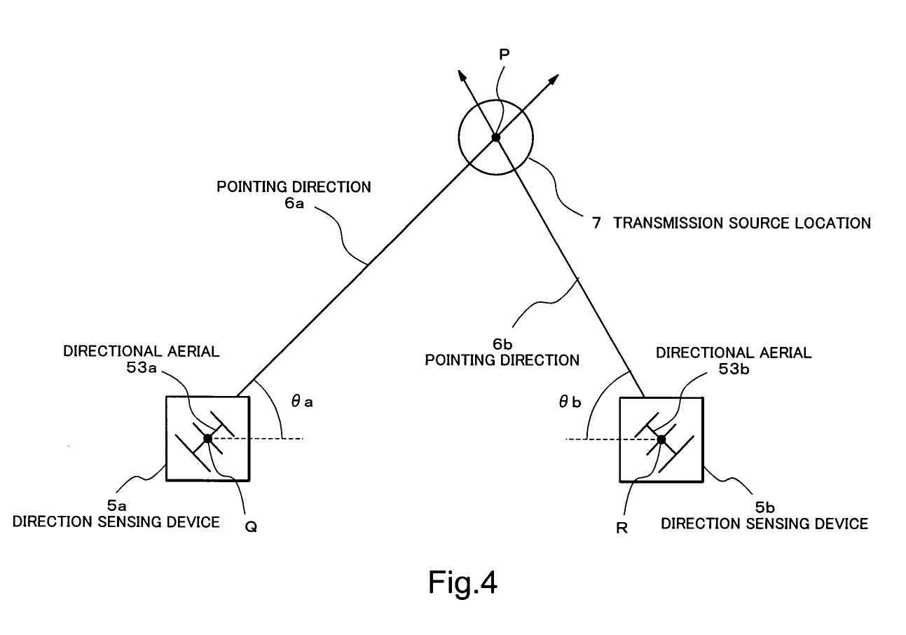

FIG. 4 illustrates the principle by which the transmission source location of the target radio wave is specified with the aid of the two direction sensing devices in the first embodiment.

Referring to FIG. 4, the positions Q, R of the direction sensing devices 5a, 5b are information obtained from the positional information 42. Pointing directions 6a, 6b and the directions of the directional aerial 53a, 53b are information specified by the above series of remote control (steps S7 and S9, steps S103 and S105, but including the case of automatic determination). The CPU 11 of the control device 3 can find out a transmission source location 7 (coordinate value P) of the target radio wave by carrying out a geometric calculation on the basis of those pieces of information.

Further in step S59, the CPU 11 generates, for example, map screen information where the location of the specified transmission source is plotted by referring to the map information 41 previously stored in the database 20. The CPU 11 sends the generated map screen information to the information terminal 1 (or may send information on the location (address) of the transmission source or the like at an appropriate timing). The series of operations in step S59 are realized through the execution of the notification program 135 by the CPU 11.

Using the operating Web browser, the CPU 31 of the information terminal 1 displays the map screen where the location of the transmission source is plotted, on the basis of the map screen information received from the control device 3 (step S11).

Upon receiving a result specified in step S11, the user of the information terminal 1 logs out from the control device 3 (step S13). In response to the log-out, the CPU 11 of the control device 3 stops the processing of charging the user of the information terminal 1 (step S61).

Thus, according to this embodiment, in providing the user of the communication terminal 1 having an environment connectible to the internet 2 with the service of specifying the transmission source location of a target radio wave, the control device 3 first provides the communication terminal 1 with the remote control functions of the two direction sensing devices 5 via the internet 2. This supports the user in the operation of specifying the direction in which the target radio wave arrives in the two direction sensing devices 5. The control device 3 then specifies the transmission source location of the target radio wave on the basis of the specified direction of arrival and the positional information indicating the positions where the two direction sensing devices 5 exist. The control device 3 provides a series of these services after authentication and the charging processing.

That is, in this embodiment, the aforementioned service of specifying the radio wave transmission source location is offered to common users as a commercial activity (business).

Further, any user (the information terminal 1) wishing to specify a location can readily utilize common services quickly via the internet 2 only by preparing an environment enabling the use of a prevailing Web browser. In this case, the precision with which the radio wave transmission source location is specified is common to all the information terminals 1 desiring the specification of location, and is high enough to be unsusceptible to influences of the equipments to be used or sensing skills.

As described above as the related art, it used to take a long time to find a solution in the case where an individual requests a public office to specify the location of a radio wave transmission source. In contrast, according to this embodiment, the user of the information terminal 1 can quickly specify the transmission source location of a target radio wave through a simple operation whenever he or she wishes to do so.

Namely, according to the aforementioned embodiment, the service of precisely specifying the transmission source location of a target radio wave can be quickly provided upon a request made by a common user. Also, the above series of services can be effectuated as a commercial activity (business).

### Second Embodiment

A second embodiment, which is based on the radio wave transmission source location specifying system according to the aforementioned first embodiment, will now be described.

The following description will focus on the characteristic part of this embodiment. As regards the construction identical or similar to that of the aforementioned first embodiment, duplication of the description is avoided by using the same reference numerals.

The description of this embodiment handles a case where a request for a certain service has been made simultaneously by a plurality of information terminals 1 (1a, 1b) in specifying the location of a radio wave transmission source through a procedure identical or similar to that of the radio wave transmission source location specifying system according to the first embodiment.

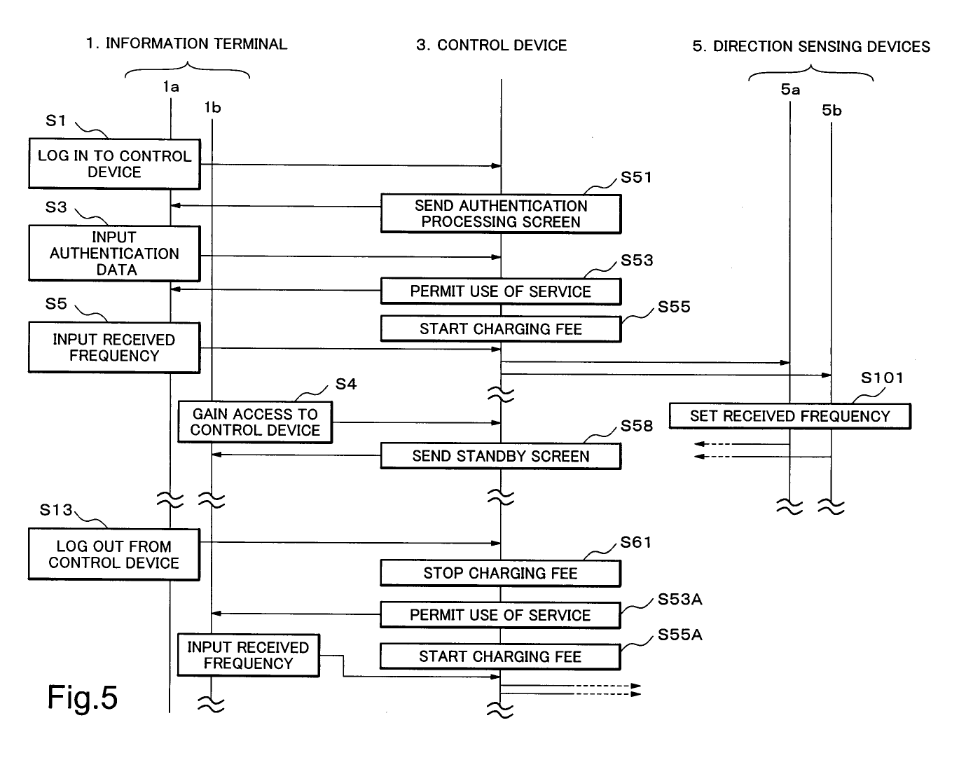

FIG. 5 is a sequence diagram showing the procedures through which the information terminal, the control device, and the direction sensing devices are operated until the transmission source location of a target radio wave is specified in the second embodiment.

Referring to FIG. 5, upon receiving a request for a service from the information terminal 1a, the CPU 11 of the control device 3 starts, for the information terminal 1a, the series of processings for specifying a radio wave transmission source as described above in the first embodiment. In response, the aforementioned series of processings are started in the information terminal 1a and two direction sensing devices 5a, 5b as well.

If the information terminal 1b has newly gained access to the control device 3 while the information terminal 1a is receiving a service (step S4), the CPU 11 of the control device 3 sends standby screen information without allowing the information terminal 1b to use the service (step S58). Thus, until the information terminal 1a finishes using the service, the CPU 11 forces the information terminal 1b to wait to use the service.

Subsequently, the CPU 11 of the control device 3 stops the charging processing in response to the detection of log-out of the information terminal 1a (step S61). The CPU 11 then allows the information terminal 1b in its standby state to use the service, and thereafter, starts the series of processings of specifying the location of a radio wave transmission source as described above in the first embodiment (step S53A, step S55A . . . ).

In the second embodiment described above, if a request for a certain service has been made simultaneously by a plurality of information terminals 1, exclusion control is performed to make that one of the information terminals which has gained access later wait. Accordingly, in addition to the effect described in the first embodiment, the second embodiment is suited to be applied to a case where the control device 3 possesses a relatively small processing capacity or a case where the number of the direction sensing devices 5 is small.

### Third Embodiment

A third embodiment, which is based on the radio wave transmission source location specifying system according to the aforementioned first embodiment, will now be described.

The following description will focus on the characteristic part of this embodiment. As regards the construction identical or similar to that of the aforementioned first embodiment, duplication of the description is avoided by using the same reference numerals.

This embodiment also deals with a case where a request for a certain service has been made simultaneously by a plurality of information terminals 1 (1a, 1b) as is the case with the above-mentioned second embodiment when the location of a radio wave transmission source is specified through a procedure identical or similar to that of the radio wave transmission source location specifying system according to the first embodiment. In this embodiment, however, concurrent processings are permitted in this case.

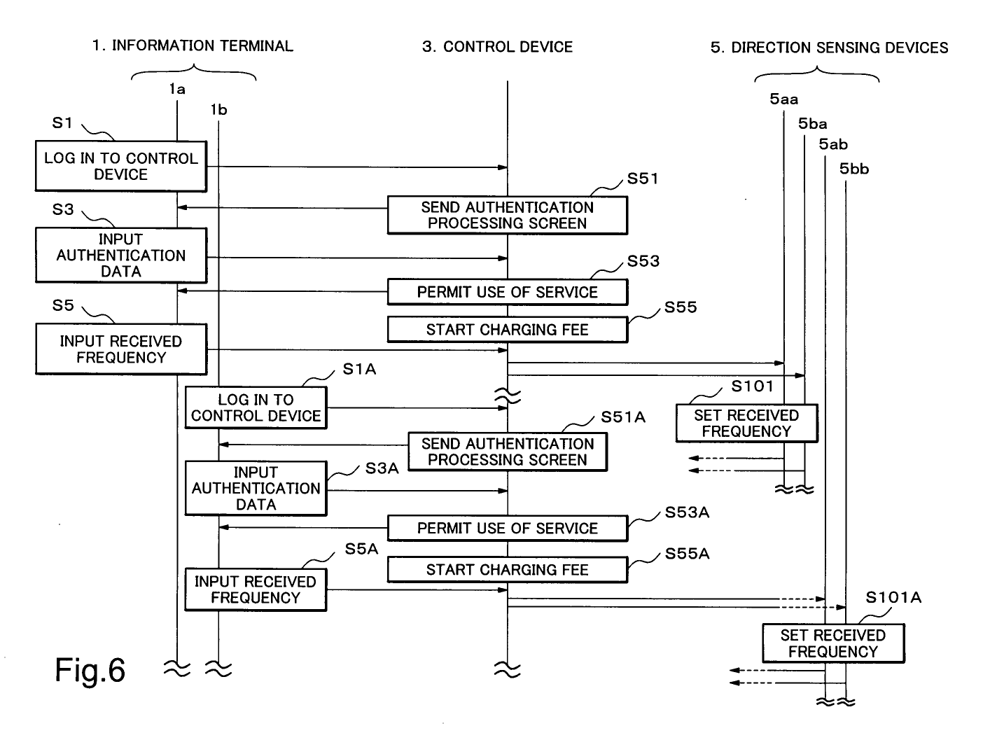

FIG. 6 is a sequence diagram showing the procedures through which the information terminal, the control device, and the direction sensing devices, are operated until the transmission source location of a target radio wave is specified in the third embodiment.

Referring to FIG. 6, upon receiving a request for a service from the information terminal 1a, the CPU 11 of the control device 3 starts, for the information terminal 1a, the series of processings for specifying a radio wave transmission source as described above in the first embodiment. In response, the aforementioned series of processings are started in the information terminal 1a and two direction sensing devices 5aa, 5ba as well.

If the information terminal 1b has newly gained access to the control device 3 while the information terminal 1a is receiving the service (step S4), the CPU 11 of the control device 3 activates the respective processes of the authentication program 131, the charging program 132, the remote control program 133, the transmission source location detecting program 134, and the notification program 135 for the information terminal 1b. Thus, a series of processings including log-in (step S1A), the transmission of an authentication processing screen (step S51A) and the inputting of authentication data (step S3A) are started between the control device 3 and the information terminal 1b, with the direction sensing devices 5ab, 5bb being targeted for remote control. The contents of these series of processings are identical or similar to the processing procedure (step S1, step S51, step S3 and so on) that is carried out with the information terminal 1a with the direction sensing devices 5aa, 5ba being targeted for remote control.

According to the third embodiment of the system configuration as described hereinabove, in addition to an effect identical or similar to that of the first embodiment, the users of the information terminals 1 are provided with services in parallel. Thus, the operating rate of the control device 3 can be enhanced, and therefore, highly efficient business can be conducted.

### Fourth Embodiment

A fourth embodiment, which is based on the radio wave transmission source location specifying system according to the aforementioned first embodiment, will now be described.

The following description will focus on the characteristic part of this embodiment. As regards the construction identical or similar to that of the aforementioned first embodiment, duplication of the description is avoided by using the same reference numerals.

In this embodiment as well, the location of a radio wave transmission source is specified basically through a procedure identical or similar to that of the radio wave transmission source location specifying system according to the first embodiment. In this embodiment, however, every time the location of a transmission source is specified, the control device 3 registers a record in the database 20. This record is obtained by correlating the frequency of a radio wave targeted for specification, positional information on the specified transmission source, and information on a specified date or time with one another.

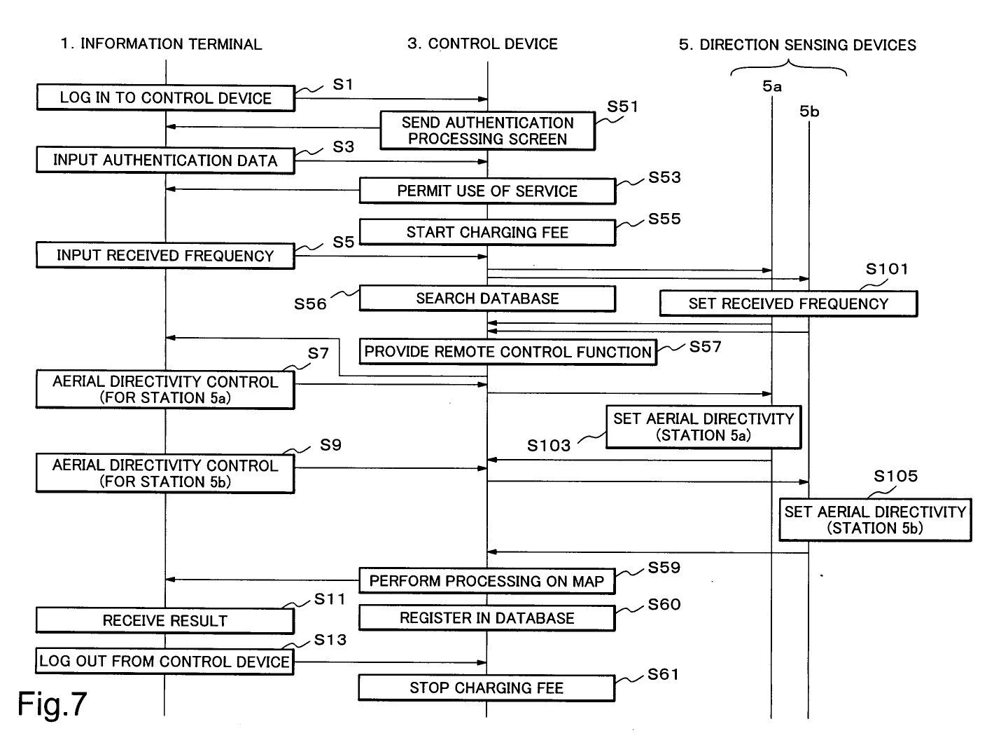

FIG. 7 is a sequence diagram showing the procedures through which the information terminal, the control device, and the direction sensing devices are operated until the transmission source location of a target radio wave is specified in the fourth embodiment.

Referring to FIG. 7, upon receiving a request for a service from the information terminal 1, the CPU 11 of the control device 3 first allows the information terminal 1 to use the service (step S53) and performs the charging processing (step S55). In this embodiment, however, if a target radio wave frequency is input to the information terminal 1 in step S5, the CPU 11 of the control device 3 conducts a search in the database 20 (step S56) while setting the frequency for the direction sensing devices 5a, 5b (step S101). Namely, in step S56, the CPU 11 of the control device 3 conducts a search in the database 20 using the target radio wave frequency input to the information terminal 1 by the user as a search key.

If any record is extracted in step S56, the CPU 11 sends information constituting the extracted record (frequency, the location of the transmission source, the specified date or time, and the like) to the information terminal 1 in providing the remote control function in step S57. The CPU 31 of the information terminal 1 then supports the user in the operation of specifying the direction in which the target radio wave arrives, in remotely operating the direction sensing devices 5a, 5b in steps S7 and S9.

As one mode of the support mentioned above, it is contemplable, for example, to display the received frequency, the location of the transmission source, and the information on the specified date or time on the direction sensing device operational screen (FIG. 3) using characters, symbols, and the like. Alternatively, it is also appropriate to autonomously control the turning unit 54 so as to direct the directional aerial 53 toward the location of the transmission source.

The CPU 11 of the control device 3 then stores a record including frequency and information on date or time into the database 20 as to the positional information on the newly specified transmission source.

According to the fourth embodiment of the system configuration as described hereinabove, in addition to an effect identical or similar to that of the first embodiment, the user of the information terminal 1 can recognize records concerning the interference in the past. Accordingly, the user can easily confirm whether or not the past search result includes a case of the same frequency, and hence, can more efficiently specify a target radio wave to be currently specified.

The user may be allowed to determine in the information terminal 1 whether to accept support through the use of the record extracted from the database 20. In this case, the fee to be charged may be changed depending on whether the user has accepted support or not.

### Modification Examples of Respective Embodiments

The description of the aforementioned respective embodiments has been made as to an exemplary case where the direction sensing devices 5 are installed on the field in advance and where the positional information 42 indicating the positions of the individual direction sensing devices is registered in the database 20.

On the other hand, in the present modification example, the direction sensing devices 5 are mobile stations such as vehicles (automobiles) or mobile phones. In this case, the direction sensing devices 5 as mobile stations need to be equipped with a position detecting unit such as a GPS (Global Positioning System) for detecting the location (current position) of the self device (own device). It is to be noted herein that positional information detected by the position detecting unit and the map information 41 are based on a common-standard coordinate system. Furthermore, the direction sensing devices 5 as mobile stations need to be equipped with a detection unit such as a gyro for detecting the orientation of the self device.

In the aforementioned respective embodiments, in order to broaden the area where the service of specifying the transmission source location of a target radio wave is provided, it is necessary to install a great number of direction sensing devices 5 on the field. In contrast, according to the present modification example, since the direction sensing devices 5 are mobile stations, the number of the direction sensing devices 5 required for the specification of a location can be minimized even in the case where such a broad service provision area is realized. Therefore, this modification example is preferable.

The present invention, which has been described citing the aforementioned respective embodiments as examples, is achieved by providing the above-mentioned information terminal 1, control device 3, and direction sensing devices 5 with computer programs capable of realizing the functions (procedures) illustrated in the sequence diagram referred to in the description of the present invention, reading out the computer programs into the CPU's of the respective devices, and then executing them. Further, it is appropriate that the computer programs supplied into the devices be stored in a storage device such as a readable/writable memory or a hard disk drive.

In the above-mentioned case, common procedures can now be adopted as a method of supplying the computer programs into the respective devices. For instance, these programs may be installed into the devices via various recording media including a floppy (registered trademark) disk and a CD-ROM, or may be downloaded from the outside via a communication line such as internet. In such a case, the present invention is constituted by codes of the computer programs or storage media.

The programs 131 to 135 executed by the aforementioned control device 3 are not limited to any system configuration realized on a single computer. In other words, the programs 131 to 135 may also be executed organically in an environment in which they are suitably distributed on a plurality of computers that are scattered on a communication line.

In the examples explained in the aforementioned respective embodiments, the respective processing procedures are carried out via the control device 3 in the system configuration composed of the information terminal 1, the control device 3, and the direction sensing devices 5. However, if an adequate fee can be charged to the information terminal 1 (user) or if gratuitous services are provided with no charge, it is appropriate that identical or similar processing procedures be carried out in a system configuration in which the information terminal 1 directly communicates with the direction sensing devices 5. In this case, it is appropriate that the control device 3 provide the information terminal 1 with programs necessary for the implementation of the above respective processing steps in response to the log-in of the information terminal.

The program codes executed in the respective devices may be provided in the state of being stored in a storage medium or may be transmitted via a transmission medium.

In the respective embodiments and their modification examples described hitherto, (a) the control device 3 provides the information terminal 1 with the remote control function of remotely controlling the operations of the two direction sensing devices in response to a request of a user in the information terminal 1. (b) In the information terminal 1, the user specifies an arrival direction in which a target radio wave with the predetermined frequency arrives by remotely controlling the operations of the direction sensing devices by means of the remote control function thus provided. In response to the specification of the arrival direction, the control device 3 specifies a transmission source location of the target radio wave on the basis of the arrival direction and positional information on the direction sensing devices. (c) The control device 3 then notifies the user of information on the specified transmission source location of the target radio wave in such a manner that the user can recognize the information in the information terminal.

Consequently, according to the aforementioned respective embodiments and their modification examples, the service of precisely specifying the transmission source location of a target radio wave can be quickly provided, through the above summarized processing arrangements (a) to (c), at the request of a common user.

In the aforementioned respective embodiments and their modification examples, the present invention has been described based on an exemplary case of specifying the transmission source location of a radio wave in radio communication. However, the scope of application of the present invention is not limited to radio waves. That is, the present invention is widely applicable to electromagnetic waves (so-called electric waves). In this case, the present invention is preferable because of its capability to specify the transmission source of an illegal radio wave unintended for communication, for example, a radio wave intended to destroy electronic circuits incorporated in third-party communication equipments.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

1. An electromagnetic wave transmission source location specifying system that specifies a location to be specified from where a target electromagnetic wave with a predetermined frequency is transmitted, comprising:
remote control function providing means for providing an information terminal to be used by a user, via a communication line, with a remote control function enabling remote control of operations of a plurality of direction sensing devices for sensing a direction in which an electromagnetic wave with a set frequency arrives;
transmission source location specifying means for specifying a transmission source location of the target electromagnetic wave, in response to specification of an arrival direction in which the target electromagnetic wave with the predetermined frequency arrives, based on the arrival direction and positional information on the direction sensing devices, by remotely controlling the operations of the direction sensing devices through the remote control function; and
notification means for notifying the user of information on the transmission source location of the target electromagnetic wave specified by said transmission source location specifying means in such a manner that the user can recognize the information in the information terminal.

2. An electromagnetic wave transmission source location specifying system that specifies a location to be specified from where a target electromagnetic wave with a predetermined frequency is transmitted, the electromagnetic wave transmission source location specifying system being provided with an information terminal to be used by a user, a plurality of direction sensing devices that sense a direction in which an electromagnetic wave with a set frequency arrives, and a control device capable of communicating with the information terminal and the direction sensing devices via a communication line, comprising:
remote control function providing means for providing the information terminal, from the control device, with a remote control function enabling remote control of operations of the direction sensing devices;
transmission source location specifying means for specifying a transmission source location of the target electromagnetic wave in the control device, in response to specification of an arrival direction in which the target electromagnetic wave with the predetermined frequency arrives, based on the arrival direction and positional information on the direction sensing devices, by remotely controlling the operations of the direction sensing devices through the remote control function; and
notification means for notifying the user of information on the transmission source location of the target electromagnetic wave specified by said transmission source location specifying means in such a manner that the user can recognize the information in the information terminal.

3. The system according to claim 1, further comprising:
charging means for providing the user with at least one of services available from said remote control function providing means, said transmission source location specifying means, and said notification means upon payment of a fee.

4. The system according to claim 1, wherein said transmission source location specifying means includes support means for supporting the user of the information terminal in an operation of specifying an arrival direction in which a target electromagnetic wave with the predetermined frequency arrives, by referring to a database in which electromagnetic wave frequency and electromagnetic wave arrival direction are correlated with each other.

5. The system according to claim 1, wherein the direction sensing devices are mobile stations equipped with position detecting means for detecting a current position of the self device as the positional information.

6. The system according to claim 1, wherein:
said remote control function providing means provides remote operations of two of the direction sensing devices through the remote control function; and
said transmission source location specifying means specifies a transmission source location of the target electromagnetic wave based on an arrival direction of the target electromagnetic wave individually specified by the two direction sensing devices and on positional information on the two direction sensing devices.

7. The system according to claim 1, wherein said transmission source location specifying means includes automatic specification means for specifying an arrival direction in which a target electromagnetic wave with the predetermined frequency arrives through remote control of operations of the direction sensing devices in response to a request operation of the user and specifying a transmission source location of the target electromagnetic wave based on the specified arrival direction and positional information on the direction sensing devices.

8. An electromagnetic wave transmission source location specifying method of specifying a location to be specified from where a target electromagnetic wave with a predetermined frequency is transmitted, comprising:
providing an information terminal to be used by a user, via a communication line, with a remote control function enabling remote control of operations of a plurality of direction sensing devices for sensing a direction in which an electromagnetic wave with a set frequency arrives;
specifying a transmission source location of the target electromagnetic wave, in response to specification of an arrival direction in which the target electromagnetic wave with the predetermined frequency arrives, based on the arrival direction and positional information on the direction sensing devices, by remotely controlling the operations of the direction sensing devices through the remote control function; and
notifying the user of information on the transmission source location of the target electromagnetic wave specified in such a manner that the user can recognize the information in the information terminal.

9. An electromagnetic wave transmission source location specifying method of specifying a location to be specified from where a target electromagnetic wave with a predetermined frequency is transmitted, by using an information terminal to be used by a user, a plurality of direction sensing devices that sense a direction in which an electromagnetic wave with a set frequency arrives, and a control device capable of communicating with the information terminal and the direction sensing devices via a communication line, comprising:
providing the information terminal, from the control device, with a remote control function enabling remote control of operations of the direction sensing devices;
specifying a transmission source location of the target electromagnetic wave in the control device, in response to specification of an arrival direction in which the target electromagnetic wave with the predetermined frequency arrives, based on the arrival direction and positional information on the direction sensing devices, by remotely controlling the operations of the direction sensing devices through the remote control function; and
notifying the user of information on the transmission source location of the target electromagnetic wave specified in such a manner that the user can recognize the information in the information terminal.

10. The method according to claim 8, further comprising:
providing the user with at least one of services available from said providing, said specifying, and said notification upon payment of a fee.

11. An information processing apparatus that specifies a location to be specified from where a target electromagnetic wave with a predetermined frequency is transmitted by communicating with an information terminal to be used by a user via a communication line and a plurality of direction sensing devices for sensing a direction in which an electromagnetic wave with a set frequency arrives, comprising:
remote control function providing means for providing the information terminal with a remote control function enabling remote control of operations of the direction sensing devices;
transmission source location specifying means for specifying a transmission source location of the target electromagnetic wave, in response to specification of an arrival direction in which the target electromagnetic wave with the predetermined frequency arrives, based on the arrival direction and positional information on the direction sensing devices, through remote control of the operations of the direction sensing devices by the remote control function; and
notification means for notifying the user of information on the transmission source location of the target electromagnetic wave specified by said transmission source location specifying means in such a manner that the user can recognize the information in the information terminal.

12. The apparatus according to claim 11, further comprising:
charging means for providing the user with at least one of services available from the remote control function providing means, the transmission source location specifying means, and the notification means upon payment of a fee.

13. The apparatus according to claim 11, further comprising:
wait request means which, if there are a plurality of the information terminals wishing to specify a transmission source location of the target electromagnetic wave, requests a succeeding one of the information terminals to wait until the supply of information on the transmission source location of the target electromagnetic wave to a preceding one of the information terminals is completed.

14. The apparatus according to claim 11, wherein, if there are a plurality of the information terminals wishing to specify a transmission source location of the target electromagnetic wave, the remote control function providing means, the transmission source location specifying means, and the notification means are individually activated for each of the information terminals.

15. The apparatus according to of claim 11, wherein said transmission source location specifying means includes automatic specification means for specifying an arrival direction in which a target electromagnetic wave with the predetermined frequency arrives through remote control of operations of the direction sensing devices in response to a request operation of the user and specifying a transmission source location of the target electromagnetic wave based on the specified arrival direction and positional information on the direction sensing devices.

16. The apparatus according to claim 11, wherein a man-machine interface that is provided in the information terminal through the remote control function includes:
operation means allowing a user to change directions of receiving devices installed in the direction sensing devices; and
display areas indicating receiving levels of the target electromagnetic wave in the direction sensing devices.

17. An electromagnetic wave transmission source location specifying apparatus that specifies a location to be specified from where a target electromagnetic wave with a predetermined frequency is transmitted by communicating with an information terminal to be used by a user via a communication line and a plurality of direction sensing devices for sensing a direction in which an electromagnetic wave with a set frequency arrives, wherein the apparatus performs:
(a) providing the information terminal with a remote control function enabling remote control of operations of the direction sensing devices;
(b) specifying a transmission source location of the target electromagnetic wave, in response to specification of an arrival direction in which the target electromagnetic wave with the predetermined frequency arrives, based on the arrival direction and positional information on the direction sensing devices, through remote control of the operations of the direction sensing devices by the remote control function; and
(c) notifying the user of information on the transmission source location of the target electromagnetic wave specified in such a manner that the user can recognize the information in the information terminal.

18. A computer program operating a computer to perform as an information processing apparatus that specifies a location to be specified from where a target electromagnetic wave with a predetermined frequency is transmitted by communicating via a communication line with an information terminal to be used by a user and a plurality of direction sensing devices for sensing a direction in which an electromagnetic wave with a set frequency arrives, the computer program causing the computer to implement:
a remote control function providing function of providing the information terminal with a remote control function enabling remote control of operations of the direction sensing devices;
a transmission source location specifying function of specifying a transmission source location of the target electromagnetic wave, in response to specification of an arrival direction in which the target electromagnetic wave with the predetermined frequency arrives, based on the specified arrival direction and positional information on the direction sensing devices, through remote control of the operations of the direction sensing devices by the remote control function; and
a notification function of notifying the user of information on the transmission source location of the target electromagnetic wave specified by said transmission source location specifying function in such a manner that the user can recognize the information in the information terminal.

19. The system according to claim 1, wherein the target electromagnetic wave is a radio wave for radio communication.

20. The apparatus according to claim 11, wherein the target electromagnetic wave is a radio wave for radio communication.

21. The apparatus according to claim 17, wherein the target electromagnetic wave is a radio wave for radio communication.
